(19) United States
(12) Patent Application Publication
(10) Pub. No.: US 2009/0279844 A1
(43) Pub. Date: Nov. 12, 2009

(54) RECORDING APPARATUS, RECORDING METHOD, RECORDING PROGRAM, AND INTEGRATED CIRCUIT

(76) Inventor: Hiroaki Shimazaki, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/440,680

(22) PCT Filed: Sep. 18, 2007
(86) PCT No.: PCT/JP2007/068044

§ 371 Date: Mar. 10, 2009

(30) Foreign Application Priority Data
Sep. 19, 2006 (JP) 2006-25303

(51) Int. Cl. H04N 5/91; H04N 7/26

(52) U.S. Cl. 386/70; 386/109; 386/126; 386/E05.001

(57) ABSTRACT

It is an object of the present invention to provide a recording apparatus which reduces the compression distortion generated on the menu screen included in menu data when recording compression-coded menu data, and generates the compression-coded menu data including a menu screen with a good image quality. A recording and reproducing apparatus (100) which performs compression-coding on an image in which an image element is arranged on a background image, and records data corresponding to the compression-coded image on a recording medium, the recording and reproducing apparatus (100) including an image generating unit (111) which generates menu data indicating the image in which the image element is arranged on the background image such that at least a part of an outer boundary of the image element is consistent with a boundary of one of a macroblock and an orthogonal transform block used for the compression-coding, a compression-multiplexing unit (105) which compression-codes the menu data generated by the menu generating unit, and a record-processing unit (106) which records the menu data compression-coded by the compression-multiplexing unit (105) on the recording medium (10).

### TECHNICAL FIELD

The present invention relates to a recording apparatus which records contents data including audio and image on a recording medium.

### BACKGROUND ART

There are conventional apparatuses which record, when reproducing recorded contents data, data including a menu screen for listing the contents data (hereinafter referred to as “menu data”) in a recordable Digital Versatile Disc (DVD) (see Patent Reference 1, for example).

A possible method for recording the menu data includes generating image data including the menu screen itself in which a predetermined standard image or the thumbnails of the screens included in the contents are arranged on a background image (hereinafter referred to as the “menu screen data”), and recording the menu screen data as compression-coded data of image (hereinafter referred to as “coded menu data”).

Here, the term menu data refers to both the menu screen data and the coded menu data. More specifically, the menu screen data is menu data before compression-coding, and the coded menu data is the compression-coded menu data.

FIG. 1 shows an example of menu screen included in the conventional menu data recorded on the recording medium using the above-described method.

On the menu screen shown in FIG. 1, a thumbnail 601, a thumbnail 602, a thumbnail 603, a thumbnail 604, a thumbnail 605, and a thumbnail 606 are arranged on a background image 600.

Here, the term “thumbnail” refers to a part of image included in the contents recorded on the recording medium. More specifically, the thumbnail includes one screen taken out among the screens included in the contents and reduced in size.

On the menu screen shown in FIG. 1, standard images including title characters such as “Title 1”, each corresponding to each of the thumbnails, characters such as “RAM” which display record information, characters such as “(1/3)” which display information related to the pages on the menu screen, characters and graphics such as “Page 2” and an arrow which guide screen transition when the menu screen is composed of multiple screens are arranged on the background image 600.

Coding the menu screen data including the menu screens by image compression-coding generates the coded menu data. In general, the image compression-coding is performed by a coding method using Discrete Cosine Transform (DCT), such as JPEG, MPEG-2, MPEG-4, and H.264.

### Patent Reference 1: Japanese Unexamined Patent Application Publication No. 2004-318923

### DISCLOSURE OF INVENTION

### Problems that Invention is to Solve

When the disc menu screen is compression-coded, there is a problem that the image quality deteriorates compared to the case where the natural image is compressed, since the compression is performed on the image in which thumbnails are arranged on the background image that has no correlation with the thumbnails.

As described above, the thumbnail is, for example, generated based on a piece of images included in the respective contents. Accordingly, there is no correlation between the thumbnail images in general. Thus, there is no correlation among the thumbnails 601 to 606 shown in FIG. 1.

Furthermore, when arranging the thumbnails on the background image as the menu screen, an image generated as a graphic or a separately-prepared still picture is used for the background image in general, and thus there is no correlation between the background image and each of the thumbnails. Therefore, there is no correlation among the background image 600 and the thumbnails 601 to 606 shown in FIG. 1.

Meanwhile, the image compression-coding compresses the image data using the correlation between the pixels of the images to be compressed. For this reason, the menu screen shown in FIG. 1 is more likely to generate compression distortions upon compression, and deterioration in image quality is more likely to occur compared to the natural image that has relatively high correlation within the whole screen.

More particularly, in the image compression-coding, the screen is divided into blocks and processing is performed per block in general. Here, as shown in the block 610 shown in FIG. 1, when one block includes both the background image 600 and the thumbnail 601, the compression distortion is apparent especially along the outer boundary of the thumbnail 601, since there is no correlation therebetween.

The present invention has been conceived in view of the problems, and it is an object of the present invention to provide a recording apparatus which reduces the compression distortion generated on the menu screen included in menu data when recording the compression-coded menu data, and generates compression-coded menu data including a menu screen with a good image quality.

### Means to Solve the Problems

In order to achieve the above object, the recording apparatus according to the present invention is a recording apparatus which performs compression-coding on an image in which an image element is arranged on a background image, and records data corresponding to the compression-coded image on a recording medium, the recording apparatus including: a menu generating unit which generates menu data indicating the image on which the image element is arranged on the background image such that at least a part of an outer boundary of the image element is consistent with a boundary of one of a macroblock and an orthogonal transform block used for the compression-coding; an image compression unit which compression-codes the menu data generated by the menu generating unit; and a recording unit which records the menu data compression-coded by the image compression unit on the recording medium.

As described above, the image element arranged on the image shown by the menu data is arranged so that at least a part of the outer boundary is consistent with the boundary of the macroblock or the orthogonal transform block used for compression-coding. With this, the outer boundary of the image element will not be included within the macroblock or the orthogonal transform block. Accordingly, it is possible to prevent the pixels of the image element having low correlation with the background image and the pixels of the background image from being mixed in the same macroblock or the orthogonal transform block. Thus, it is possible to reduce the compression distortion generated in the block, and obtain good image quality.

It is preferable that the recording apparatus further includes: an image selection unit which selects an image included in image data; and a thumbnail creation unit which creates a thumbnail of the image selected by the image selection unit, in which the menu generating unit generates the menu data indicating an image in which the thumbnail is arranged on the background image such that at least a part of a straight-line section included in an outer periphery of the thumbnail created by the thumbnail creation unit is consistent with the boundary of one of the macroblock and the orthogonal transform block used for the compression-coding.

As described above, when the image element is a thumbnail, at least a part of the outer boundary of the thumbnail is arranged to be consistent with the boundary of the macroblock or the orthogonal transform block used for compression coding. With this, the outer boundary of the thumbnail will not be included in the macroblock or the orthogonal transform block. Accordingly, it is possible to prevent the pixels of the thumbnail having low correlation with the background image, and the pixels of the background image from being mixed in the same macroblock or the same orthogonal transform block. Thus, it is possible to reduce the compression distortion generated in such a block, and obtain good image quality.

It is also preferable that the thumbnail creation unit creates the thumbnail such that a length of each side of the image selected by the image selection unit is an integral multiple of a length of each side of one of the macroblock and the orthogonal transform block used for the compression coding.

As described above, the length of each side of the thumbnail is the integral multiple of the length of the sides included in the macroblock or the orthogonal transform block. When such a thumbnail is arranged such that at least a part of the outer boundary of the thumbnail is consistent with the boundary of the macroblock or the orthogonal transform block used for compression-coding, it is possible to increase the outer boundary of the thumbnail being consistent with the boundary of the macroblock or the orthogonal transform block compared to the case where the length of each of the sides is not an integral multiple. More particularly, when the thumbnail is a rectangle, all of the sides composing the outer boundary of the thumbnail are consistent with the boundary of the macroblock or the orthogonal transform block. Accordingly, it is possible to prevent the pixels of the thumbnail having low correlation with the background image, and the pixels of the background image from being mixed in the same macroblock or the same orthogonal transform block. Thus, it is possible to reduce the compression distortion generated in the block, and obtain good image quality.

It is also preferable that the menu generating unit transmits at least one of information indicating a location, on the background image, of the thumbnail arranged on the background image and information indicating a size of the thumbnail.

As described above, the menu generating unit transmits the location and the size of the arranged thumbnail to the image compression unit. With this, the image compression unit can specify the location of the thumbnail in the menu screen indicated by the menu data based on the location and the size of the thumbnail. Thus, it is possible to perform compression-coding on the background image and the thumbnail under different conditions. The background image is a simple image and the thumbnail is a natural image. Changing compression-coding conditions for the background image and natural image having different image property, allows effective compression-coding of the image.

It is also preferable that the image compression unit further determines an outer boundary of the thumbnail based on at least one of the information indicating the location, on the background image, of the thumbnail transmitted by the menu generating unit and the information indicating the size of the thumbnail, and not to perform filtering on the outer boundary of the determined thumbnail.

As described above, the image compression unit does not filter the outer periphery that has been determined as the outer periphery of the thumbnail based on the location and the size of the thumbnail. Filtering reduces the compression distortion on the boundary of the block. Not performing the filtering on the outer periphery of the thumbnail makes the boundary of the thumbnail on the background image clearer.

It is also preferable that the menu generating unit selects, from among a group of standard images held in advance, a standard image to be arranged on the background image, and to generate the menu data indicating the image in which the selected standard image is arranged on the background image such that at least a part of straight-line section included in the outer boundary of the standard image is consistent with the boundary of one of the macroblock used for the compression-coding and the orthogonal transform block.

As described above, when the image element is a standard image, at least a part of the outer boundary of the standard image is arranged to be consistent with the boundary of the macroblock and the boundary of the orthogonal transform block used for the compression coding. With this, the outer boundary of the standard image is not included in the macroblock or the orthogonal transform block. Accordingly, it is possible to prevent the pixels of the standard image having low correlation with the background image, and the pixels of the background image from being mixed in the same macroblock or the same orthogonal transform block. Thus, it is possible to reduce the compression distortion generated in the block, and obtain good image quality.

It is also preferable that the menu generating unit generates the standard image such that at least a length of a part of straight-line section in a horizontal direction and a vertical direction included in the outer boundary of the selected standard image is an integral multiple of a length of each side of a block used for the compression coding, and generates the menu data indicating the image in which the selected standard image is arranged on the background image such that at least a part of the straight-line section included in the outer boundary of the generated standard image is consistent with the boundary of one of the macroblock and the orthogonal transform block used for the compression-coding.

As described above, the length of the straight-line section included in the outer boundary of the standard image is the integral multiple of the length of each side included in the macroblock or the orthogonal transform block. When the standard image is arranged such that at least the part of the outer boundary is consistent with the boundary of the macroblock and the orthogonal transform block used for the compression-coding, it is possible to increase the length of the outer boundary of the standard image being consistent with the boundary of the macroblock or the orthogonal transform block compared to the case where the length of each side is not an integral multiple. More specifically, when the standard image is a rectangle, all of the sides composing the thumbnail are consistent with the boundary of the macroblock or the orthogonal transform block. Accordingly, it is possible to reduce a possibility that the pixels of the standard image having low correlation with the background image, and the pixels of the background image being mixed in the same macroblock or the same orthogonal transform block. Thus, it is possible to reduce the compression distortion generated in the block, and obtain good image quality.

It is also preferable that the menu generating unit transmits information indicating a location, on the background image, of the standard image arranged on the background image and information indicating a size of the standard image to the image compression unit.

Thus, the menu generating unit transmits the location and the size of the arranged standard image to the image compression unit. With this, the image compression unit can specify the location of the standard image in the menu screen indicated by the menu data based on the location and the size of the standard image. Thus, it is possible to compression-codes the background image and the standard image under different conditions, which allows effective compression-coding of image.

It is also preferable that the image compression unit further determines an outer boundary of the standard image based on one of the information indicating the location, on the background image, of the standard image transmitted by the menu generating unit and the information indicating the size of the standard image, and not to perform filtering on the outer boundary of the determined thumbnail.

As described above, the image compression unit does not perform filtering on the outer boundary that has been determined as the outer boundary of the image element based on the location and the size of the image element. Filtering reduces the compression distortion on the boundary of the block. Not performing the filtering on the outer periphery of the thumbnail makes the boundary of the thumbnail on the background image clearer.

Furthermore, the image compression unit codes the standard image by performing a quantization different from a quantization performed on the background image, the standard image being indicated by the information indicating the location, on the background image, of the standard image arranged on the background image and the information indicating the size of the standard image, the standard image being transmitted by the menu generating unit.

As described above, the image compression unit codes the standard image by performing the quantization different from the quantization performed on the background image. The image compression unit can specify the location of the image element on the menu screen indicated by the menu data based on the location and the size of the image element, and thus it is possible to perform a quantization different from the quantization performed on the background image, only on the standard image. This allows performing rougher quantization on the standard image, for example, which enables more efficient compression-coding.

Note that the present invention may be implemented as, in addition to the recording apparatus, a method for controlling the recording apparatus, a program causing a computer system to execute the method, and a recording medium on which the program is recorded.

Furthermore, the present invention may also be implemented as an integrated circuit incorporated in the recording apparatus, design data configuring the integrated circuit on a program logic device, and a recording medium on which the design data is recorded thereon.

### EFFECTS OF THE INVENTION

According to the present invention, by matching the location and the size of the thumbnails or the standard image arranged on the menu screen with the boundary of the macroblock or the orthogonal transform block prevents the pixels of the thumbnail image having no correlation from being mixed into the macroblock and the orthogonal transform block including the background image outside the respective thumbnails, and thus the compression distortion in these blocks can be reduced. Accordingly, it is possible to generate coded menu data including a menu screen having a good image quality.

Furthermore, it is also possible to reduce compression distortion of the menu image by generating the standard image arranged on the menu screen in the same manner as the location and the size of the thumbnail are determined. Thus, it is possible to generate a coded menu including a good-quality menu screen.

### BRIEF DESCRIPTION OF DRAWINGS

FIG. 1 shows an example of menu screen included in the conventional menu data recorded on a recording medium.

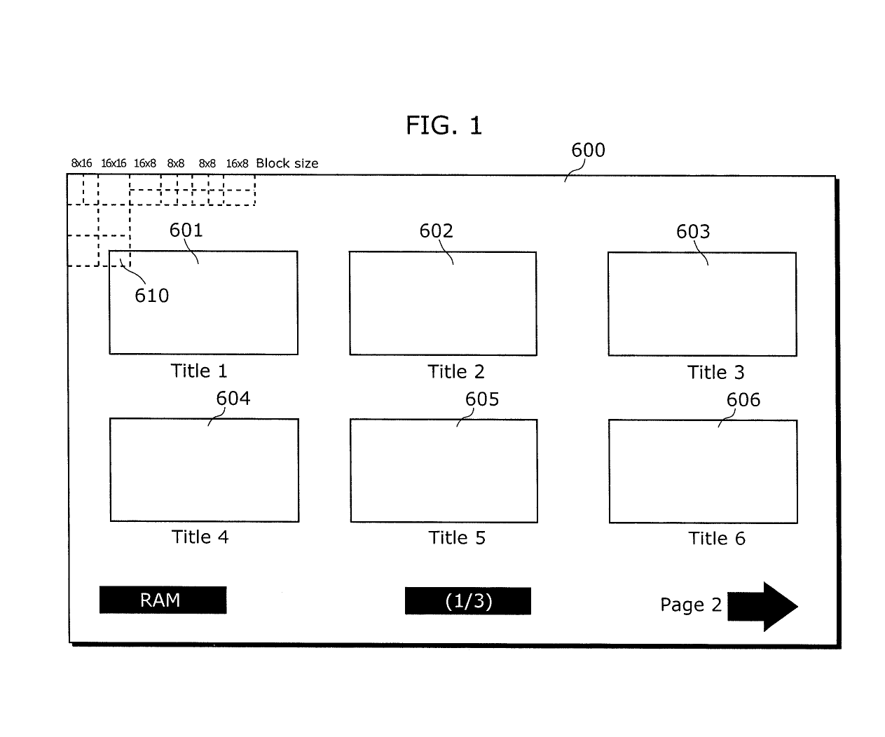

FIGS. 2A and 2B are perspective views showing appearance of a recording and reproducing apparatus according to an embodiment of the present invention.

FIG. 3 shows a hardware configuration of the recording and reproducing apparatus according to the embodiment of the present invention.

FIG. 4 is a flowchart showing an example of process related to creation of thumbnails performed by the recording and reproducing apparatus according to the embodiment of the present invention.

FIG. 5 is a flowchart showing an example of process related to creation of menu screen performed by the recording and reproducing apparatus according to the embodiment of the present invention.

FIG. 6 shows a display example of the menu screen according to the embodiment of the present invention.

FIG. 7 shows a configuration of files recorded on a recording medium according to the embodiment of the present invention.

FIG. 8 shows data configuration of the menu file according to the embodiment of the present invention.

### NUMERICAL REFERENCES

10 Recording medium
100 Recording and reproducing apparatus
101 Lens group
102 Imaging unit
103 A/D conversion unit
104 Image signal processing unit
105 Compression-multiplexing unit
106 Record processing unit
108 Drive control unit
109 Input unit
110 Control unit
111 Image generating unit
112 Display unit
113 Image signal processing unit
114 Demultiplex-decompression unit
115 Reproduction processing unit
116 Image memory
117 Thumbnail memory
118 Image reduction unit

### BEST MODE FOR CARRYING OUT THE INVENTION

### Embodiment

The following describes an embodiment according to the present invention with reference to the drawing.

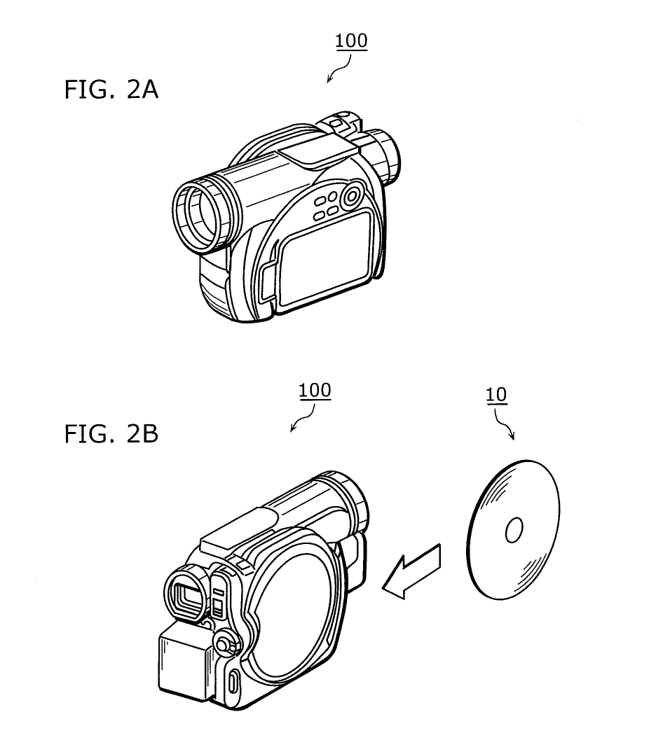

FIG. 2 is a perspective view showing the appearance of a recording and reproducing apparatus 100 according to the embodiment. The recording and reproducing apparatus 100 is a digital video camera shown in FIG. 2, for example. FIG. 2A is a perspective view from the imaging lens side of the recording and reproducing apparatus 100 and FIG. 2B is a perspective view from the ocular lens side of the recording and reproducing apparatus 100.

As shown in FIG. 2B, the recording and reproducing apparatus 100 can record the audio and image contents on a recording medium 10. Furthermore, the recording and reproducing apparatus 100 can reproduce the audio and image contents recorded on the recording medium 10.

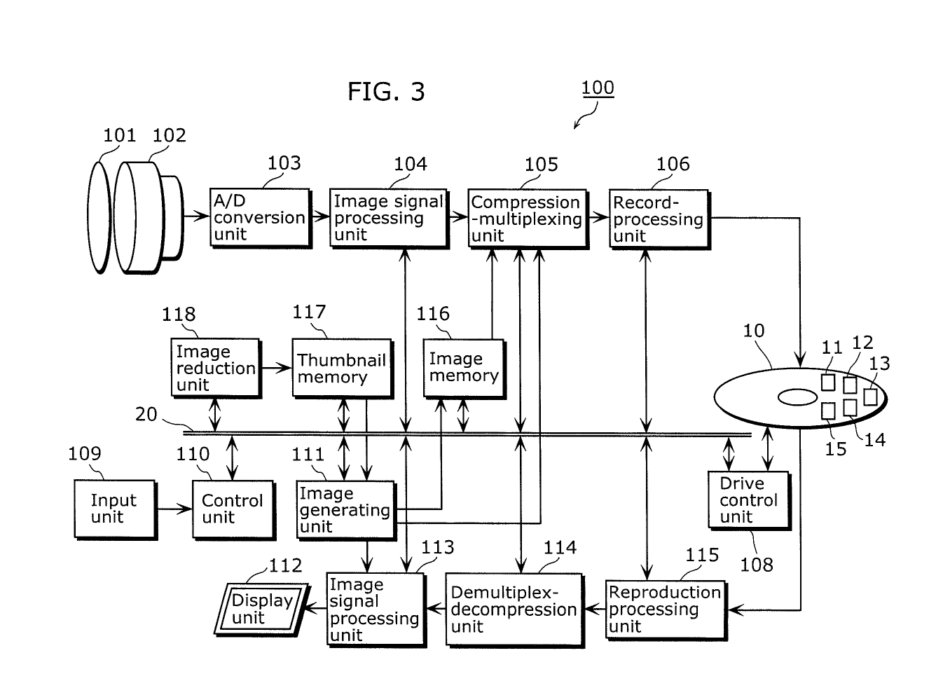

FIG. 3 shows a hardware configuration of the recording and reproducing apparatus 100 according to the embodiment.

As shown in FIG. 3, the recording and reproducing apparatus 100 includes a lens group 101 for imaging, an imaging unit 102, an A/D conversion unit 103, an image signal processing unit 104, a compression-multiplexing unit 105, a record processing unit 106, a drive control unit 108, an input unit 109, a control unit 110, an image generating unit 111, a display unit 112, an image signal processing unit 113, a demultiplex-decompression unit 114, a reproduction processing unit 115, an image memory 116, a thumbnail memory 117, and an image reduction unit 118.

The image signal processing unit 104, the compression-multiplexing unit 105, the record-processing unit 106, the drive control unit 108, the control unit 110, the image generating unit 111, the image signal processing unit 113, the demultiplex-decompression unit 114, the reproduction processing unit 115, the image memory 116, the thumbnail memory 117, and the image reduction unit 118 are connected to one another via an internal bus 20, and mutually transmit and receive data via the internal bus 20. These components can be implemented as one or more integral circuits. Furthermore, it is possible to realize the components as a function achieved by an integrated circuit which executes a software program.

The lens group 101 includes optical lenses.

The imaging unit 102 is composed of imaging devices and others, and captures images inputted via the lens group 101. The imaging unit 102 outputs the captured image to the A/D conversion unit 103 as an analog signal.

The A/D conversion unit 103 converts the analog signal output from the imaging unit 102 into a digital signal. The imaging unit 102 outputs the digital signal obtained by the conversion to the image signal processing unit 104.

The image signal processing unit 104 converts the digital signal output from the A/D conversion unit 103 into an image signal. The image signal processing unit 104 outputs the image signal obtained by the conversion to the compression-multiplexing unit 105, selects a representative image from the images included in the image signal at the same time, and outputs an image signal including the selected representative image to the image reduction unit 118.

The compression-multiplexing unit 105 compresses and multiplexes the image signal output from the image signal processing unit 104 and the audio signal output from a component that is not shown, in accordance with the image compression-coding method such as the MPEG-2 and H.264. The compression-multiplexing unit 105 outputs content data generated by multiplexing the image signal and the audio signal to the record-processing unit 106.

The record-processing unit 106 writes the content data output from the compression-multiplexing unit 105 into the recording medium 10.

The drive control unit 108 controls a driving apparatus which drives the recording medium 10.

The input unit 109 receives the operations by the user via the input device. The input unit 109 outputs the received user operation as the operation information to the control unit 110.

The control unit 110 controls, for performing recording process and reproduction process in the recording and reproducing apparatus 100, the image signal processing unit 104, the compression-multiplexing unit 105, the record-processing unit 106, the drive control unit 108, the image generating unit 111, the image signal processing unit 113, the demultiplex-decompression unit 114, and the reproduction processing unit 115.

The image generating unit 111 generates menu screen data containing a menu screen which lists the contents recorded on the recording medium 10 in coordination with the image signal processing unit 104, the image memory 116, the thumbnail memory 117, and the image reduction unit 118. Details of the operation to generate the menu screen data is to be described later. The image generating unit 111 outputs the generated menu screen data to the image memory 116 and the image signal processing unit 113.

The image memory 116 is a memory which holds the menu screen data generated by the image generating unit 111.

The thumbnail memory 117 is a memory which holds the data including the thumbnails (hereinafter referred to as “thumbnail data”).

The image reduction unit 118 obtains an image signal of representative image of the contents from image signal processing unit 104, creates thumbnail data of the representative image indicated by the obtained image signal, and stores the thumbnail data in the thumbnail memory 117.

The display unit 112 displays the image signal output from the image signal processing unit 113 on a monitor, for example.

The image signal processing unit 113 converts decompressed contents output from the demultiplex-decompression unit 114 into an image signal. The image signal processing unit 113 outputs the image signal generated by the conversion to the display unit 112. The image signal processing unit 113 multiplexes the menu image generated by the image generating unit 111 to the display unit 112 and outputs the multiplexed menu image or the menu image as it is, as an image signal as necessary.

The demultiplex-decompression unit 114 demultiplexes and decompresses the contents output from the reproduction processing unit 115 in accordance with the coding method used by the compression-multiplexing unit 105, such as MPEG-2 and H.264. The demultiplex-decompression unit 114 outputs the contents generated by the decompression to the image signal processing unit 113.

The reproduction processing unit 115 reads the contents to be reproduced from the recording medium 10. The reproduction processing unit 115 outputs the read contents to the demultiplex-decompression unit 114.

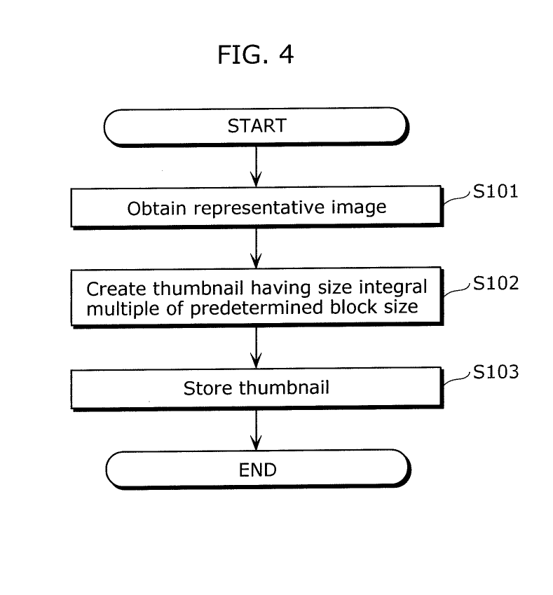

FIG. 4 is a flowchart showing an example of process related to creation of thumbnails performed by the recording and reproducing apparatus 100 according to the embodiment of the present invention.

The image reduction unit 118 obtains the image signal of the representative image of the content from the image signal processing unit 104 (S101).

The image reduction unit 118 creates thumbnail data containing a thumbnail which is the representative image indicated by the obtained image signal reduced to a size in an integral multiple of a predetermined block size (S102). Here, the predetermined block size refers to, for example, a size of macroblock or a size of an orthogonal transformation block.

The image reduction unit 118 stores the created thumbnail data in the thumbnail memory 117 (S103), and terminates the process.

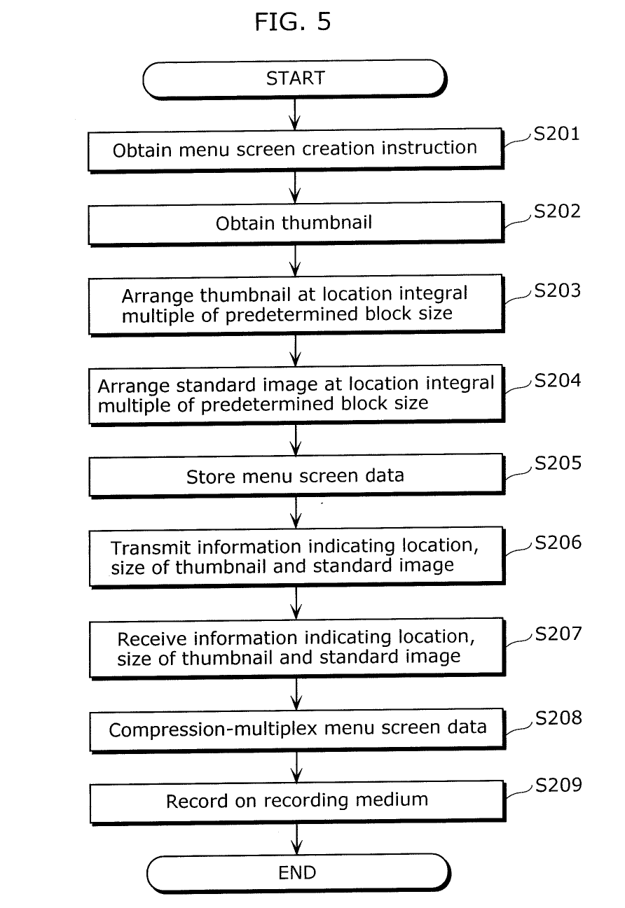

FIG. 5 is a flowchart showing an example of process related to creation of menu screen performed by the recording and reproducing apparatus 100 according to the embodiment of the present invention.

The image generating unit 111 obtains menu creation instruction that the user inputs to the input unit 109 via the control unit 110 (S201).

The image generating unit 111 obtains the thumbnail data held by the thumbnail memory 117 (S202).

When the location of each pixel is represented on the coordinates which have a corner on the top left of the background image as the original point and increase to the right in the horizontal direction and to the bottom in the vertical direction per pixel, the image generating unit 111 generates menu screen data in which thumbnails are arranged on locations where the horizontal distance from the original point of the pixel of the thumbnail at the top left corner is a multiple of the horizontal size of a predetermined block, and where the vertical distance from the original point of the pixel of the thumbnail at the top left corner is a multiple of the horizontal size of a predetermined block (hereinafter referred to as “integral location”) (S203).

The predetermined block includes, for example, a macroblock and an orthogonal transform block used for image compression-coding. The process is an example of a process for generating the menu data containing a screen in which the straight-line sections of the thumbnails are arranged on the background image being consistent with the boundary of the macroblock or the orthogonal transform block used for image compression-coding.

The image generating unit 111 selects a standard image to be arranged on the menu screen out of a group of standard images held therein, and generates the menu screen data where the thumbnails are arranged on the integral location of the menu screen indicated in the menu screen data generated in the thumbnail obtaining process (S202) (S203).

The predetermined block includes, for example, a macro block and an orthogonal transform block used for image compression-coding. The process is an example of a process for selecting a standard image to be arranged on the background image out of a group of standard images held therein in advance, and for generating the menu data containing a screen in which the straight-line sections of the standard image are arranged on the background image being consistent with the boundary of the macroblock or the orthogonal transform block used for image compression-coding.

The image generating unit 111 stores the menu screen data indicating the menu screen in which the thumbnails and the standard images are arranged in the image memory 116 (S205).

The image generating unit 111 transmits the information indicating the locations and the sizes of the thumbnails and the standard images to the compression-multiplexing unit 105 (S206).

The compression-multiplexing unit 111 receives the information indicating the locations and the sizes of the thumbnails and the standard images from the image generating unit 111 (S207).

The compression-multiplexing unit 105 obtains the menu screen data from the image memory 116, refers to the information showing the locations and the sizes of the thumbnails and the standard images, and generates coded menu data which is compression-coded menu screen data without performing filtering such as deblocking filter on the outer boundaries of the thumbnails and the standard images. The compression-multiplexing unit 105 simultaneously generates the compression-multiplexed contents data by compression-multiplexing other image data and audio data on the coded menu data at the same time (S208).

Filtering such as the deblocking filter reduces compression distortion on the boundary of the block. Meanwhile, not filtering only the outer boundary of the thumbnails and the standard image makes the boundaries of the thumbnails and the background image to be clear.

The record-processing unit 106 obtains the compression-multiplexed contents data including the coded menu data from the compression-multiplexing unit 105, and records the obtained compression-multiplexed contents data on the recording medium 10 (S209).

As described above, the recording and reproducing apparatus 100 of the embodiment arranges the thumbnails on the integral locations of the background image. The thumbnails are generally rectangles, and thus at lease two sides of the thumbnails can be consistent with to the boundary of the predetermined block. Furthermore, in this embodiment, the size of the thumbnail created by the image reduction unit 118 is an integral multiple of the predetermined block size. Arranging the thumbnails at the integral locations of the background image allows all of the four sides of the thumbnail being consistent with the boundary of the predetermined block.

As described above, by having the sides of the thumbnail consistent with the boundary of the predetermined block used for compression-coding eliminates the compression distortion at the boundary.

Note that the thumbnails are described as images obtained by reducing the screens contained in the contents; however, the thumbnails may also be obtained in another way. For example, when the screen included in the contents does not satisfy a predetermined number of pixels determined as the size of a thumbnail to be arranged on the menu screen, the thumbnail may be an image obtained by enlarging the screen.

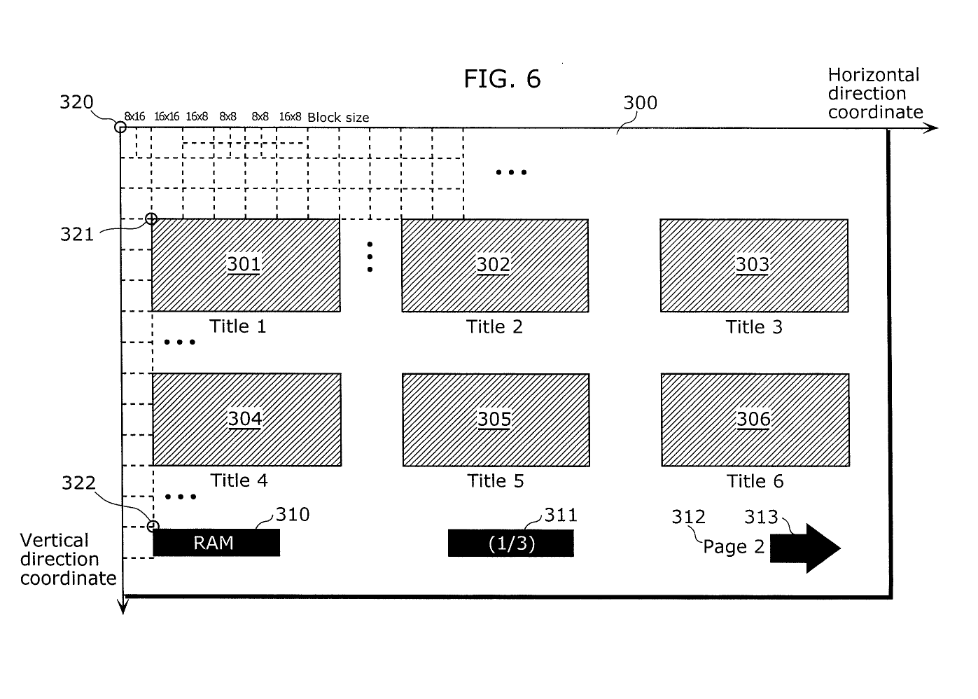

FIG. 6 is an example of a menu image generated by the image generating unit 111. The menu image is composed of the background image 300, the thumbnails 301 to 306, and the standard images 310 to 313.

A top left corner 321 of the thumbnail 301 shown in FIG. 6 is arranged on the first integral location on the left and the third integral location from the top on the macroblocks shown as small rectangles in FIG. 6. Furthermore, the horizontal length of the thumbnail 301 is as long as six macroblocks, while the vertical length of the thumbnail 301 is as long as three macroblocks. Other thumbnails 302 to 306 have the same size, and the vertices of the respective thumbnails 302 to 306 are arranged on the integral locations.

Thus, all of the four sides of thumbnails match the boundaries of the macroblocks.

In addition, a top left corner 322 of the standard image 310 is also arranged on the integral location. Top left corners of other standard images 311 to 313 are also arranged on the integral locations.

With this, at least a part of the standard image is consistent with the boundary of a macroblock when the standard image includes a straight line in the horizontal direction or in the vertical direction starting from the top left corner of the standard image.

The menu data containing the menu screen shown in FIG. 6 is generated through the processes described with reference to FIGS. 4 and 5.

Note that it is necessary to hold the thumbnail until the menu screen data is started to be generated, more specifically, until the user instructs the recording and reproducing apparatus 100 to perform finalizing process. However, this can be achieved by reading the thumbnails that have been stored in the thumbnail memory 117 once by the record-processing unit 106 and recording the thumbnail on the recording medium 10 as a thumbnail file. In this case, when performing the finalizing process, the reproduction processing unit 115 reads the thumbnail file from the recording medium 10. The thumbnail that has been read is stored on the thumbnail memory 117, and the image generating unit 111 generates the menu screen data.

Alternatively, instead of the image signal processing unit 104 obtaining the representative image upon shooting, a part of the contents included in the recording medium 10 may be sequentially reproduced, and the image signal processing unit 113 may obtain the representative image and may output the representative image to the image reduction unit 118, when performing the finalizing process. With this method, it is not necessary to record the thumbnail file on the recording medium 10; however, it takes longer to perform the finalizing process.

When the user sends an instruction for performing the finalizing process on the recording medium 10 via the input unit 109, the image generating unit 111 sequentially reads the thumbnails 301 to 306 from the thumbnail memory 117, generates the menu image data including the menu image shown in FIG. 6 by arranging the background image 300 generated by the image generating unit 111 and the standard images 310 to 313 on the background image 300, and stores the menu image data on the image memory 116. Note that, it is possible to record all of or a part of the standard images 310 to 313 on the recording medium 10 as data separate from the menu image as necessary. The detail of the method will be described later.

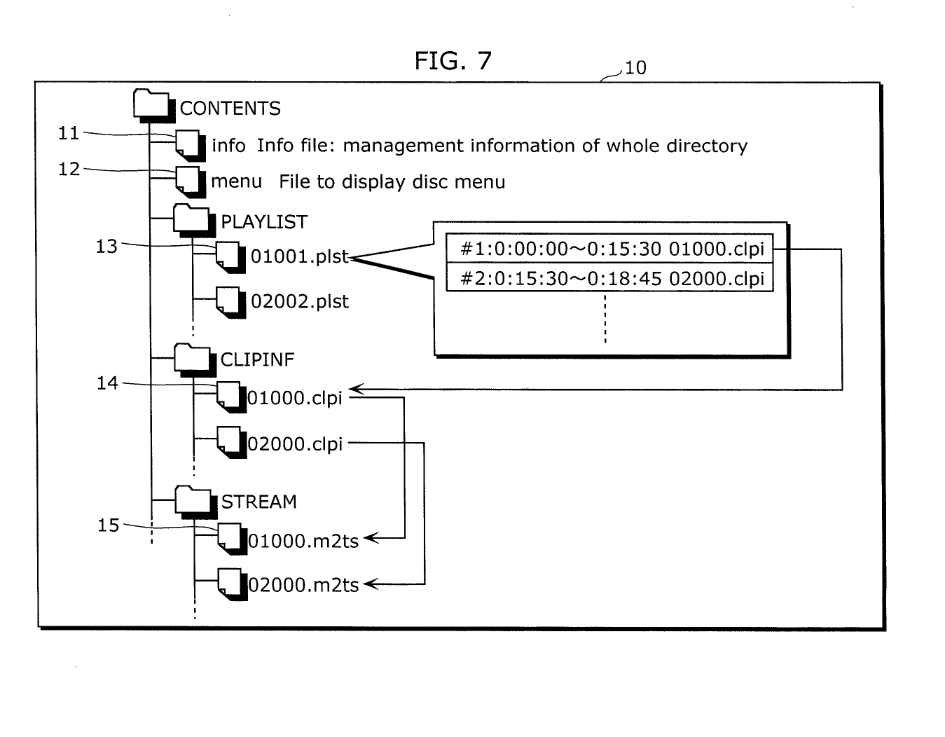

FIG. 7 shows a configuration of files stored in the recording medium 10 according to this embodiment. FIG. 7 shows an example where an information file 11 (info), a menu file 12 (menu), a playlist folder (PLAYLIST), a clip information folder (CLIPINF), and a stream folder (STREAM) are stored under a contents folder (CONTENTS).

In the information file 11 (info), management information of the whole directory is recorded. In the menu file 12 (menu), information for configuring the menu and others is included.

Furthermore, under the playlist folder (PLAYLIST), playlist files, for example, “01001.plst” and “02002.plst” are stored. Each of the playlist files includes information regarding reproduction order or reproduction time of the contents associated with clip information file which will be described later.

FIG. 7 shows, for example, the playlist file 13 (01000.clpi) includes information indicating that the contents associated with “01000.clpi” which will be described later is reproduced first at “0:00:00 to 0:15:30”.

Furthermore, under the clip information folder (CLIPINF), clip information files such as “01000.clpi” and “02000.clpi” are stored. Each of the clip information files includes time table which associates the time information and the location of the image data, and achieves partial reproduction and trick-play.

FIG. 7 shows that “01000.m2ts” which will be described later is associated with the clip information file 14 (01000.clpi).

Furthermore, stream files “01000.m2ts” and “02000.m2ts” are stored under the stream folder (STREAM). Each stream file includes an AV data file.

The control unit 110 uses three-types of files, namely the playlist files, the clip information files, and the stream files upon controlling the reproduction. Clip information file to be reproduced and the reproduction time are recorded on the playlist file. When the playlist file is reproduced, the designated clip information file is referred to, and the stream file specified by the information such as the time table is reproduced.

For example, the playlist file 13 (01001.plst) includes information indicating the clip file “01000.clpi” which is the first clip, and the clip file “02000.clpi” which is the second clip are reproduced in that order. Here, with respect to the first clip, the stream file “01000.m2ts” associated with the clip information file “01000.clpi” is reproduced. With respect to the second clip, the stream file “02000.m2ts” associated with the clip information file “02000.clpi” is reproduced.

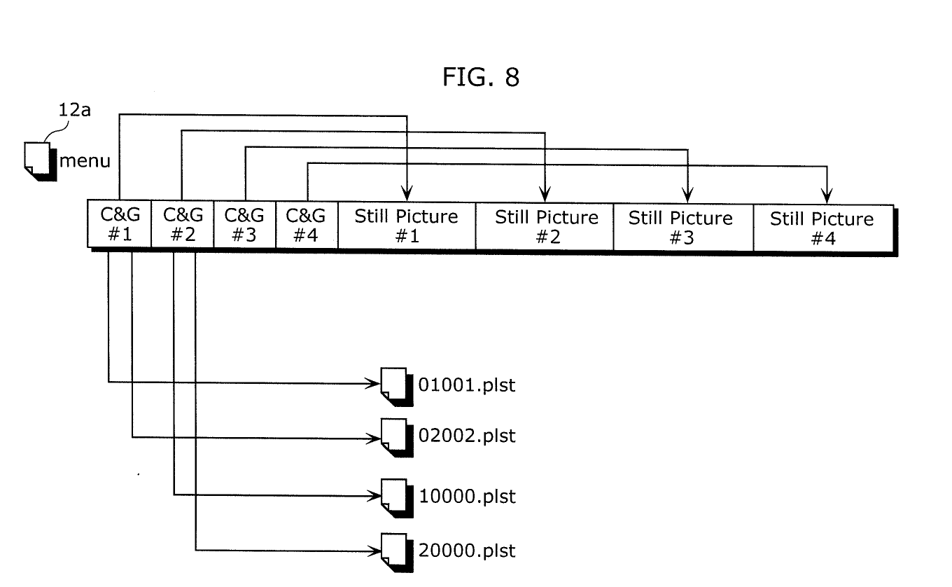

FIG. 8 shows data configuration of the menu file according to this embodiment.

As shown in FIG. 8, the menu file 12a is a menu file in which the contents stored in the recording medium 10 as the menu images listed in plural pages (for example, see FIG. 6) is described. Here, the menu file 12a shown in FIG. 8 includes “C&G”, which is the data associated with each playlist file such as “C&G #1”, “C&G #2”, “C&G #3”, and “C&G #4” from the top. Subsequently, the menu file 12a includes “Still Picture”, for example, “Still Picture #1”, “Still Picture #2”, “Still Picture #3”, and “Still Picture #4”, each of which is associated with each “C&G”.

“C&G” is data configured of the control information and the standard image information.

“Still picture” is coded data of the menu image. Furthermore, with respect to some standard images, for example, a frame or a button, a command for controlling the display of the menu is associated.

For example, the recording and reproducing apparatus 100 displays the menu image on the first page including the thumbnail image of the clip described in the playlist file (01001.plst) based on the “C&G #1”. Furthermore, when an operation for displaying the menu on the next page is received from the user while the menu on the first page is displayed, the recording and reproducing apparatus 100 performs the same process on the “C&G #2” subsequent to the “C&G #1”. Afterwards, the recording and reproducing apparatus 100 displays the menu image on the second page including the thumbnail image of the clip described in the playlist file (02002.plst). Similarly, the same process is performed on the “C&G #3” and “C&G #4”.

After the reproduction according to the menu file 12a, the control unit 110 first displays a menu screen as shown in FIG. 6 using “Still Picture #1” based on “C&G #1”. Put differently, the menu image on which six thumbnail images including “opening ceremony” and “boll toss” and others are arranged on the background image is compression-coded as “Still Picture #1”. The standard image information which the user can change the color and shape thereof (for example, the arrow 313 indicating page 2 and a frame showing whether not the selection of thumbnail images is possible) is recorded on “C&G” together with the control information. The control unit 110 controls the demultiplex-decompression unit 114 to reproduce the still picture #1, controls the image generating unit 111 and the image signal processing unit 113 to generate a necessary standard image based on C&G #1, multiplexes the standard image on the still picture #1, and outputs the obtained image to the display unit 112 as the menu screen.

Subsequently, when the user performs reproduction operation by selecting the thumbnail image that he/she wants to reproduce from the menu, the control unit 110 refers to a playlist file associated with the thumbnail image, and reproduces the stream file.

In this embodiment, when the image generating unit 111 generates the menu image shown in FIG. 6, the arrangement and the sizes of the background image 300, the thumbnails 301 to 306, and the standard images 310 to 313 are limited so as to obtain good image quality upon subsequent compression-coding by the compression-multiplexing unit 105.

More specifically, when the image generating unit 111 arranges the thumbnail 301 on the background image 300, the thumbnail is arranged so that the top left corner of the thumbnail 301 is arranged on the integral location, as described above.

For example, when compression-coding is performed by the compression-multiplexing unit 105 in accordance with MPEG-2, MPEG-4, or H.264, the image generating unit 111 arranges the thumbnail 301 on the background image 300 so that the pixel 321 on the top left corner of the thumbnail 301 is on an integral location apart from multiples of 16 pixels from the original point, which is the size of the macroblock both in the horizontal direction and the vertical direction.

With this, when the compression-multiplexing unit 105 codes the menu image in FIG. 6, the boundary on top left of the thumbnail 301 is consistent with the boundary of the macroblock, after compression is performed per macroblock in the horizontal direction and the vertical direction from the original point 320. Thus, on the top side and the left side of the thumbnail 301, it is possible to avoid pixels included in the background image 300 and pixels included in the thumbnail 301 from being mixed in the same macroblock. Therefore, it is possible to prevent generation of a macroblock with large compression distortion due to the mixed pixels. The same applies to other thumbnails 302 to 306.

Furthermore, when the image reduction unit 118 reduces the representative image to generate a thumbnail and stores the thumbnail in the thumbnail memory 117, the thumbnail is generated with the size of multiple of the macroblock or the orthogonal transform block in the image compression unit both horizontally and vertically.

For example, when performing compression-coding in accordance with MPEG-2, MPEG-4 or H.264 by the compression-multiplexing unit 105, the image reduction unit 118 creates the thumbnail 301 in such a manner that the size of the thumbnail is to be a multiple of 16 pixels which is the size of macroblock both in the horizontal direction and the vertical direction.

With this, when the compression-multiplexing unit 105 codes the menu image in FIG. 6, the boundary on top left of and the boundary at the bottom side of the thumbnail 301 is consistent with the boundary of the macroblock, after compression is performed per macroblock in the horizontal direction and the vertical direction from the original point 320. Thus, on the right side and the bottom side of the thumbnail 301, it is possible to avoid pixels included in the background image 300 and pixels included in the thumbnail 301 from being mixed in the same macroblock. Therefore, it is possible to prevent the generation of a macroblock with large compression distortion due to the mixed pixels. The same applies to other thumbnails 302 to 306.

Furthermore, when the image generating unit 111 arranges the background image 300 and the thumbnails 301 to 306, it is possible to improve quality of compressed menu image by sending the information indicating the location and the size of each thumbnail to the compression-multiplexing unit 105, and optimizing the image compression algorithm using the information in the compression-multiplexing unit 105.

For example, when the compression-multiplexing unit 105 performs image compression using the H.264 compression-coding algorithm, possible methods includes the following.

The first method is not to reference the background image 300 and the thumbnails 301 to 306 one another when performing intra picture prediction. The second method is changing the initial value of quantization parameter when coding the background image 300 and when coding inside the thumbnails 301 to 306. The third method is not to use deblocking filter on the boundary of the background image 300 and the thumbnails 301 to 306 (For these methods, see, “H.264/AVC TEXTBOOK” Impress, Aug. 11, 2004, pages 106 to 113, pages 136 to 138, and pages 140 to 144 (Non-Patent Reference 1)).

As described above, the methods described using the thumbnails as an example are effective not only for the thumbnails 301 to 306, but can also be applied when arranging the standard images 310 to 313 in FIG. 6 to the menu image and performing compression-coding.

Furthermore, since the standard images, especially the arrow 313 and others are usually represented with a single color or a limited number of colors and luminance levels, it is possible to reduce the amount of data for the standard images by transmitting information indicating location and size of each standard image to the compression-multiplexing unit 105 when the image generating unit 111 arranges the background image 300 and the standard images 310 to 313, and by coding the standard images with rougher quantization step compared to the quantization step used for the background image when the compression-multiplexing unit 105 codes the standard image. Thus, it is possible to improve the image quality as a whole menu screen.

As described above, according to the recording and reproducing apparatus 100 of this embodiment, matching the location and the size of macroblock with the boundary of the macroblock or the orthogonal transform block prevents pixels of a thumbnail image having no correlation mixed into the macroblock or the orthogonal transform block including the background image outside each thumbnail, reduces the compression distortion in the block, and achieves good image quality.

Furthermore, transmitting the information indicating the location and/or the size of each thumbnail on the menu screen to the image compression unit, and compressing the image based on the location and/or the size information of each thumbnail by the image compression unit can reduce the compression distortion in the menu image and achieve good image quality.

Furthermore, for the standard images created to be multiplexed on the menu image, creating the standard image in the same manner as the location and size of the thumbnails, or performing compression on the standard image in the same manner as the thumbnails can reduce the compression distortion and obtain good image quality.

Furthermore, coding the standard image using a quantization step different from the quantization step used for the background image, based on the information indicating location and/or size of each of the standard images reduces the coded data amount in the standard images, and improves the image quality as the whole menu image.

(Other)

Although finalizing is not necessary for the rewritable recording medium, it is possible to set virtual finalizing so that the operability will be the same to the case where a write-once recording medium is used. In this case, it is possible to store a virtual finalized state by setting a finalizing flag on the rewritable recording medium as the actual finalizing performed after the menu file is recorded and indicating whether the finalizing is performed or not.

Note that the recording and reproducing apparatus according to the present invention may include a Central Processing Unit (CPU), a system Large Scale Integration (LSI), a Random Access Memory (RAM), a Read Only Memory (ROM), a Hard Disk Drive (HDD), and a network interface. Furthermore, the recording and reproducing apparatus may also include a driving apparatus which can write/read to/from a portable recording medium such as a DVD-RAM, Blu-ray™ disc, and a memory card.

Note that a recording and reproducing apparatus may be a built-in system such as a digital video camera, a digital recorder, a digital television, a game console, an IP phone, and a mobile phone, and others.

Furthermore, a program for controlling the recording and reproducing apparatus (hereinafter referred to as the recording and reproducing program) is installed on an HDD or a ROM, and each function of the recording and reproducing apparatus may be implemented by executing the recording and reproducing program.

Note that the recording and reproducing program may be recorded on a recording medium readable by a hardware system such as the computer system and the built-in system. Furthermore, the recording and reproducing program may be read and executed by other hardware system via the recording medium. This achieves each function of the recording and reproducing apparatus to be implemented on other hardware systems. Here, the computer readable recording media include an optical recording medium (CD-ROM, for example), a magnetic recording medium (hard disk, for example), a magneto optical recording medium (Magneto optical disk), and a semiconductor memory (memory card, for example), and others.

Furthermore, the recording and reproduction program may be held in the hardware system connected to a network such as the internet, and the local area network. The recording and reproducing program may also be downloaded in other hardware system via the network and executed. This achieves each function of the recording and reproducing apparatus to be implemented on other hardware systems. Here, the network includes a terrestrial broadcast network, a satellite broadcast network, a Power Line Communication (PLC), a mobile telephone network, a wired communication network (for example, IEEE 802.3 and others), and a wireless communication network (for example, IEEE 802.11 and others).

Furthermore, a recording and reproducing circuit implemented on the recording and reproducing apparatus may achieve each of the function of the recording and reproducing apparatus.

Furthermore, the recording and reproducing circuit may be configured in a full custom Large Scale Integration (LSI), a semi-custom LSI such as Application Specific Integrated Circuit (ASIC), a programmable logic device such as a Field Programmable Gate Array (FPGA), and a Complex Programmable Logic Device (CPLD), and a dynamic reconfigurable device whose circuit configuration can be dynamically rewritten.

Furthermore, the design data for configuring each of the functions of the recording and reproducing apparatus may be a program described in a hardware description language (hereinafter referred as an HDL program). The design data may also be a netlist of a gate level obtained by logic synthesis of the HDL program. Still further, the design data may also be macro cell information including the netlist of the gate level added with arrangement information and process condition. Furthermore, the design data may also be mask data determining the size and the timing. Here, an example of the hardware description language includes Very high speed integrated circuit Hardware Description Language (VHDL), Verilog-HDL, and System C.

The design data may be recorded on a recording medium readable by a hardware system such as the computer system and the built-in system. Furthermore, the design data may be read and executed by other hardware system via the recording medium. Subsequently, the design data read by other hardware systems via the recording medium may be downloaded to the programmable logic device via the download cable.

Furthermore, the design data may be held in the hardware system connected to the network such as the internet, and the local area network. The design data may also be downloaded in other hardware system via the network and executed. Subsequently, the design data obtained by other hardware systems via the network may be downloaded to the programmable logic device via the download cable.

Alternatively, the design data may be recorded on a serial ROM so that the design data can be transferred to FPGA when applying current. Furthermore, the design data recorded on the serial ROM may be downloaded directly to FPGA when applying current.

Alternatively, the design data may be generated by a microprocessor when applying current, and downloaded to FPGA.

### INDUSTRIAL APPLICABILITY

The present invention can be used as a recording and reproducing apparatus which records audio and image on a portable recording medium and reproduces the recorded audio and image. More particularly, the present invention can be utilized, for example, as a video camera which records AV data on a recording medium such as a semiconductor memory and an optical disc, and records menu information for displaying a menu screen as necessary.

1. A recording apparatus which performs compression-coding on an image in which an image element is arranged on a background image, and records data corresponding to the compression-coded image on a recording medium, said recording apparatus comprising:
a menu generating unit configured to generate menu data indicating the image on which the image element is arranged on the background image such that at least a part of an outer boundary of the image element is consistent with a boundary of one of a macroblock and an orthogonal transform block used for the compression-coding;
an image compression unit configured to compression-code the menu data generated by said menu generating unit; and
a recording unit configured to record the menu data compression-coded by said image compression unit on the recording medium.

2. The recording apparatus according to claim 1, further comprising:
an image selection unit configured to select an image included in image data; and
a thumbnail creation unit configured to create a thumbnail of the image selected by said image selection unit,
wherein said menu generating unit is configured to generate the menu data indicating an image in which the thumbnail is arranged on the background image such that at least a part of a straight-line section included in an outer periphery of the thumbnail created by said thumbnail creation unit is consistent with the boundary of one of the macroblock and the orthogonal transform block used for the compression-coding.

3. The recording apparatus according to claim 2,
wherein said thumbnail creation unit is configured to create the thumbnail such that a length of each side of the image selected by said image selection unit is an integral multiple of a length of each side of one of the macroblock and the orthogonal transform block used for the compression coding.

4. The recording apparatus according to claim 2,
wherein said menu generating unit is configured to transmit at least one of information indicating a location, on the background image, of the thumbnail arranged on the background image and information indicating a size of the thumbnail.

5. The recording apparatus according to claim 4,
wherein said image compression unit is further configured to determine an outer boundary of the thumbnail based on at least one of the information indicating the location, on the background image, of the thumbnail transmitted by said menu generating unit and the information indicating the size of the thumbnail, and not to perform filtering on the outer boundary of the determined thumbnail.

6. The recording apparatus according to claim 1,
wherein said menu generating unit is configured to select, from among a group of standard images held in advance, a standard image to be arranged on the background image, and to generate the menu data indicating the image in which the selected standard image is arranged on the background image such that at least a part of straight-line section included in the outer boundary of the standard image is consistent with the boundary of one of the macroblock used for the compression-coding and the orthogonal transform block.

7. The recording apparatus according to claim 6,
wherein said menu generating unit is configured to generate the standard image such that at least a length of a part of straight-line section in a horizontal direction and a vertical direction included in the outer boundary of the selected standard image is an integral multiple of a length of each side of a block used for the compression coding, and to generate the menu data indicating the image in which the selected standard image is arranged on the background image such that at least a part of the straight-line section included in the outer boundary of the generated standard image is consistent with the boundary of one of the macroblock and the orthogonal transform block used for the compression-coding.

8. The recording apparatus according to claim 6,
wherein said menu generating unit is configured to transmit information indicating a location, on the background image, of the standard image arranged on the background image and information indicating a size of the standard image to said image compression unit.

9. The recording apparatus according to claim 8,
wherein said image compression unit is further configured to determine an outer boundary of the standard image based on one of the information indicating the location, on the background image, of the standard image transmitted by said menu generating unit and the information indicating the size of the standard image, and not to perform filtering on the outer boundary of the determined thumbnail.

10. The recording apparatus according to claim 8,
wherein said image compression unit is configured to code the standard image by performing a quantization different from a quantization performed on the background image, the standard image being indicated by the information indicating the location, on the background image, of the standard image arranged on the background image and the information indicating the size of the standard image, the standard image being transmitted by said menu generating unit.

11. The recording apparatus according to claim 1,
wherein said image compression unit is configured to compression-code contents data including the image data in addition to the menu data, and
said recording unit is configured to record the contents data compression-coded by said image compression unit on the recording medium together with the compression coded menu data.

12. A recording method of compression-coding an image in which an image element is arranged on a background image, and recording data corresponding to the compression-coded image on a recording medium, said recording method comprising:
generating menu data indicating the image including the image element arranged on the background image such that at least a part of an outer boundary of the image element is consistent with a boundary of one of a macroblock and an orthogonal transform block used for the compression-coding;
generating compression-coded menu data by compression-coding the menu data generated in said generating; and
recording the compression-coded menu data compression-coded in said generating on the recording medium.

13. A recording program of compression-coding an image in which an image element is arranged on a background image, and recording data corresponding to the compression-coded image on a recording medium, said recording program causing a computer to execute:
generating menu data indicating the image including the image element arranged on the background image such that at least a part of an outer boundary of the image element is consistent with a boundary of one of a macroblock and an orthogonal transform block used for the compression-coding;
generating compression-coded menu data by compression-coding the menu data generated in said generating; and
recording the compression-coded menu data compression-coded in said generating on the recording medium.

14. An integrated circuit which performs compression-coding on an image in which an image element is arranged on a background image, and records data corresponding to the compression-coded image on a recording medium, said integrated circuit comprising:
a menu generating unit configured to generate menu data indicating the image on which the image element is arranged on the background image such that at least a part of an outer boundary of the image element is consistent with a boundary of one of a macroblock and an orthogonal transform block used for the compression-coding;
an image compression unit configured to compression-code the menu data generated by said menu generating unit; and
a recording unit configured to record the menu data compression-coded by said image compression unit on the recording medium.
